(19) United States
(12) Patent Application Publication
(10) Pub. No.: US 2025/0326144 A1
(43) Pub. Date: Oct. 23, 2025

(54) SHAVING RAZOR CARTRIDGE

(71) Applicant: The Gillette Company LLC, Boston, MA (US)

(72) Inventors: Jack Anthony Washington, Mendon, MA (US); Larkin Mae Gillespie, Boston, MA (US); Aiqin Li, Foxboro, MA (US)

(21) Appl. No.: 18/643,695

(22) Filed: Apr. 23, 2024

(51) Int. Cl. B26B 21/22; B26B 21/40; B26B 21/44

(52) U.S. Cl. CPC B26B 21/222; B26B 21/4018; B26B 21/4025; B26B 21/4031; B26B 21/443

(57) ABSTRACT

A shaving razor cartridge with a housing having a primary guard and a secondary cap. A bridge member is positioned between the primary guard and the secondary cap. The bridge member includes a primary cap and a secondary guard. A first blade having a first cutting edge is mounted between the primary guard and the primary cap. A first gap extends 0.70 mm to 1.25 mm from the first blade to the bridge member. A second blade having a second cutting edge is mounted between the secondary guard and the secondary cap. A second gap extends 0.70 mm to 1.25 mm from the second blade to a front face of the secondary cap. A first span from the first cutting edge to the primary guard is greater than or to equal 1.05 mm. A second span from the second cutting edge to the secondary guard is greater than 0.60 mm.

### FIELD OF THE INVENTION

The present invention relates to shaving razors and more particularly to shaving cartridges having two guards, two caps, and a plurality of blades.

### BACKGROUND OF THE INVENTION

In general, shaving razors of the wet shave type include a cartridge or blade unit with at least one blade with a cutting edge, which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). The connection of the cartridge to the handle provides a pivotal mounting of the cartridge with respect to the handle so that the cartridge angle adjusts to follow the contours of the surface being shaved. In such systems, the cartridge can be biased toward a rest position by the action of a spring-biased plunger (a cam follower) carried on the handle against a cam surface on the cartridge housing.

Razor cartridges usually include a guard which contacts the skin in front of the blade(s) and a cap for contacting the skin behind the blade(s) during shaving. The cap may comprise a water leachable shaving aid to reduce drag and improve comfort. The guard may be generally rigid, for example formed integrally with a frame or platform structure which provides a support for the blades. Guards may also comprise softer elastomeric materials to improve skin stretching. The cap and the guard aid in establishing the so-called “shaving geometry”, i.e., the parameters which determine the blade orientation and position relative to the skin during shaving, which in turn have a strong influence on the shaving performance and efficacy of the razor. The cap and the guard may aid in establishing the exposure of the blades. The blade exposure is defined to be the perpendicular distance or height of the blade edge measured with respect to a plane tangential to the skin contacting surfaces of the blade unit elements next in front of and next behind the edge. Therefore, for a three-bladed blade unit, the exposure of the first or primary blade is measured with reference to a plane tangential to the guard and the edge of the second blade, and the exposure of the third or tertiary blade is measured with reference to a plane tangential to the edge of the second blade and the cap.

The minimum acceptable exposure may be influenced by other blade unit dimensions, such as the distance from the skin engaging surface of the guard to the edge, i.e. “the span” of the primary blade. As referred to herein, “the span” means the distance from the blade edge to the skin contacting element immediately in front of that edge as measured along a tangent line extending between the said element and the blade edge. The guard may include a generally rigid guard bar that may be formed integrally with the housing or platform structure, which provides a support for the blades. Guards may also include skin stretching elements made from various types of elastomeric materials that are intended to stretch the skin and/or align hair in front of the blade.

Safety razors having cartridges with several blades have in recent years been sold in very large numbers and are generally acknowledged to give a better quality of shave, especially in terms of closeness, than single bladed razors. A blade unit having many blades can produce a closer shave than a similar blade unit with only one or two blades. However, closeness of shave obtained is only one parameter by which razor users judge the performance of a razor. Comfort is another important characteristic to consider. For example, many consumers describe themselves as having sensitive skin, which is prone to nicks, cuts and irritation. Discomfort during a shave, often described by shavers as a “pull & tug” sensation is caused by the nerves around the follicle being stimulated. This nerve stimulation can happen by moving the hairs, pulling and/or cutting the hairs and by dragging the razor cartridge over the surface of the skin.

Consumers shaving the body (e.g., chest, stomach, shoulders and back) has been steadily growing market segment among men. Historically, there have been more men that shaved their face than men that shaved their body. Accordingly, razors that were specifically designed to shave the face were also marketed to shave the body, despite the numerous anatomical differences, such as hair length, hair density, body contours. However, there are limited options available that specifically designed for body shaving. The shaving razors designs have focused primarily on facial and leg hair removal.

The removal of hair from larger surface areas of the body creates a number of challenges for consumers. In particular, the ability to efficiently shave the body remains a key unmet need for male consumers. There is thus still a need to provide a hair removal device for body hair, which effectively cuts the hair type in this area in a safe, easy, and efficient manner such that the user of the device is confident during use and thereby ensures improved hair removal end result whilst reducing likelihood of any associated irritation.

### SUMMARY OF THE INVENTION

In one aspect, the invention features, in general, a shaving razor cartridge with a housing having a primary guard at a front of the housing and a secondary cap at a rear of the housing. A bridge member is positioned between the primary guard and the secondary cap. The bridge member has a primary cap and a secondary guard. A first blade is mounted to the housing between the primary guard and the primary cap. The first blade member has a first cutting edge closest to the primary guard. A first gap extends from the first blade to the bridge member a distance of 0.70 mm to 1.25 mm. A second blade is mounted to the housing between the secondary guard and the secondary cap. The second blade member has a second cutting edge closest to the secondary cap. A second gap extends from the second blade to a front face of the secondary cap a distance of 0.70 mm to 1.25 mm. A first span from the cutting edge of the first blade to the primary guard is greater than or equal to 1.05 mm. A second span from the cutting edge of the second blade to the secondary guard is greater than 0.60 mm.

In another aspect, the invention features, in general a shaving razor cartridge with a housing having a primary guard at a front of the housing and a secondary cap at a rear of the housing. A bridge member is positioned between the primary guard and the secondary cap. The bridge member has a primary cap and a secondary guard. A first blade member has a first cutting edge closest to the primary guard. The first blade is mounted to the housing between the primary guard and the primary cap. A first gap extends from the first blade to the bridge member 0.70 mm to 1.25 mm. A second blade member has a second cutting edge closest to the secondary cap. The second blade is mounted to the housing between the secondary guard and the secondary cap. A second gap extends from the second blade and the secondary cap of 0.70 mm to 1.25 mm.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a top view of a shaving razor cartridge.

FIG. 2 is an assembly view of the shaving razor cartridge of FIG. 1.

FIG. 3 is a bottom view of the shaving razor cartridge of FIG. 1.

FIG. 4A is a section view of the shaving razor cartridge, taken generally along the line 4-4 of FIG. 1.

FIG. 4B is an enlarged section view of the shaving razor cartridge of FIG. 4A.

### DETAILED DESCRIPTION OF THE INVENTION

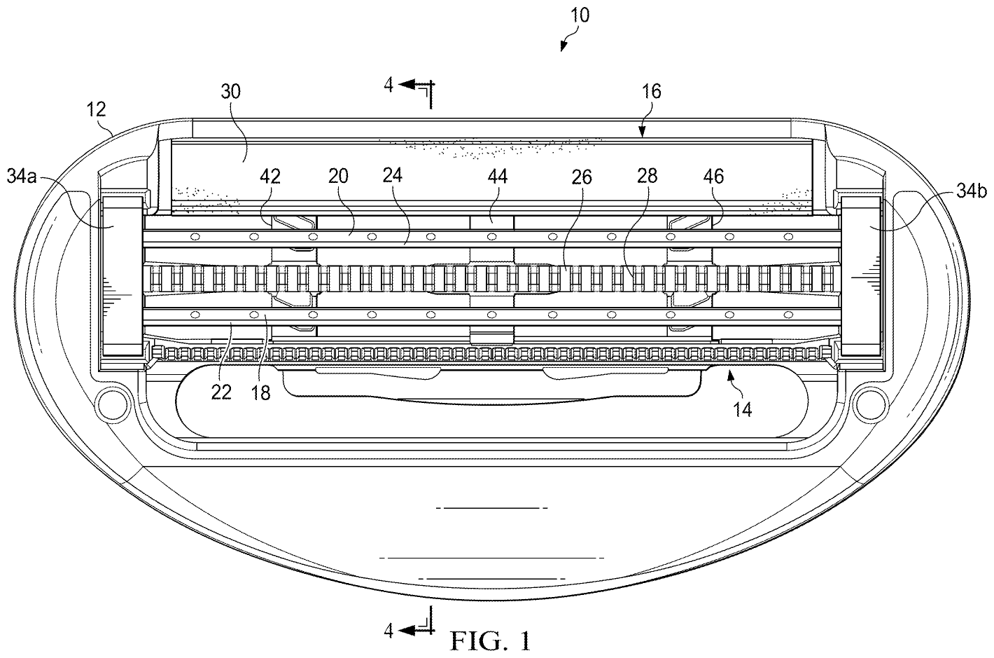

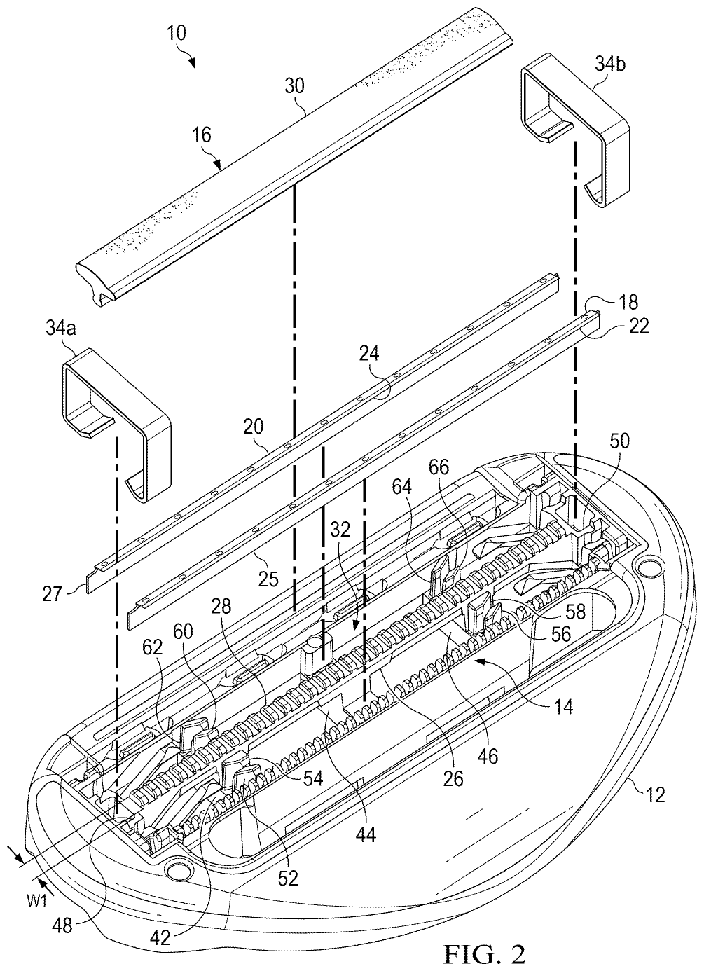

Referring to FIG. 1, a top view is shown of a shaving razor cartridge 10. The shaving razor cartridge 10 may include a housing 12 having a primary guard 14 toward a front of the housing 12 and a secondary cap 16 toward a rear of the housing 12. FIG. 2 illustrates an assembly view of the shaving razor cartridge 10. In certain embodiments, there may be a first blade 18 and a second blade 20 mounted to the housing 12 between the primary guard 14 and the secondary cap 16. Each of the blades 18 and 20 may have a respective cutting edge 22 and 24 facing in the same direction (e.g., toward the primary guard 14). The first blade 18 and the second blade 20 may each include a blade support member 25 and 27. The blade support members 25 and 27 may be a unitary part of the respective blades 18 and 20 or may be a separate element that the first and second blades 18 and 20 are mounted and secured to (e.g., by welding).

A bridge member 26 may be positioned between the first blade 18 and the second blade 20. The bridge member 26 may be integrally molded to the housing 12 or may mounted and secured to the housing 12 as a separate component. The bridge member 26 may include a plurality of spaced apart parallel ribs 28 that extend transverse to the cutting edges 22 and 24 of the blades 18 and 20. The spaced apart parallel ribs 28 may provide the added benefit of aligning hairs in front of the second blade 20 to improve cutting efficiency. The bridge member 26 may have a width “W1” of 1.0 mm to 4.0 mm and more preferably 1.0 mm to 2.25 mm. The width of the bridge member 28 may allow for proper shaving geometry to minimize double engagement of hairs and prevent hair from being cut below the skin surface. In certain embodiments, the plurality of spaced apart parallel ribs 28 may define a plurality of corresponding rinse openings extending thru the bridge member 26 to aid in the removal of cut hair and excess shave prep or soap.

The secondary cap 16 may be part of a lubrication bar 30. The housing 12 may define an opening 32 configured to receive the lubrication bar 30. The opening 32 may be a recess or extend completely through housing 12. The lubrication bar 30 may comprise a material having a lower friction than a coefficient than the housing 12. The lubrication bar 30 may comprise one or more water leachable shaving aids. The water leachable shaving aid may be formed by an injection molding, extrusion, or thermal/ultrasonic compression manufacturing process. The lubrication bar 30 may provide for lubrication behind the second blade 20, which may reduce irritation, especially on re-strokes where most of the shave prep has been removed.

In certain embodiments, the water leachable shaving aid may include a polymeric matrix comprising a water soluble polymer and a water-insoluble polymer comprising ethylene vinyl acetate (EVA). Other typical lubricious water soluble polymers may include polyethylene oxide, polyvinyl pyrrolidone, polyacrylamide, modified hydroxyalkyl cellulose, polyvinyl imidazoline, polyvinyl alcohol, polysulfone, and polyhydroxyethylmethacrylate. The preferred lubricious water-soluble polymer is polyethylene oxide. The more preferred polyethylene oxides generally are known as POLYOX (available from Union Carbide Corporation) or ALKOX (available from Meisei Chemical Works, Kyoto, Japan). These polyethylene oxides will preferably have molecular weights of about 100,000 to 8 million Daltons, most preferably about 300,000 to 5 million Daltons. It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g., POLYOX COAGULANT) and about 60% to 20% of polyethylene oxide having an average molecular weight of about 300,000 (e.g., POLYOX WSR-N-750). A 60:40 blend of these two polyethylene oxides million:300,000) is especially preferred.

The blades 18 and 20 may be spring loaded within the housing 12 such that the blades 18 and 20 are biased against one or more clips 34a and 34b. It is understood that the blades 18 and 20 may alternatively be fixed relative to the housing 12. Although the clips 34a and 34b are shown as two separate components fixing the blades 18 and 20 and bridge member 26 to the housing 12, the clips 34a and 34b may also be a single piece construction. In addition, the clips 34a and 34b may not necessarily be bent or formed around a portion of the housing 12 to secure the blades 18 and 20 and the bridge member 26 relative to the housing 12. For example, the clips 34a and 34b may be snapped fit, press fit, glued, or ultrasonically welded to the housing 12. The clips 34a and 34b may comprise a metal (e.g., aluminum or stainless steel) or a polymeric material (e.g., Noryl™ (a blend of polyphenylene oxide (PPO) and polystyrene developed by General Electric Plastics, now SABIC Innovative Plastics), acrylonitrile butadiene styrene (ABS), acetal, polypropylene, high impact polystyrene, or any combinations thereof. Other assembly methods known to those skilled in the art may also be used to secure and/or mount the blades 18 and 20 to the housing 12 including, but not limited to, wire wrapping, cold forming, hot staking, insert molding, ultrasonic welding, and adhesives.

The clips 34a and 34b may contact the cutting edges 22 and 24 of the respective blades 18 and 20. In certain embodiments, the clips 34a and 34b may be spaced apart (i.e., not in contact) from the primary cap 28 and/or the secondary guard surface 30. The spacing of the clips 34a and 34b from the bridge member 26 may facilitate proper skin contact of the bridge member 26 and the cutting edges 22 and 24. For example, if the clips 34a and 34b extended over or around the bridge member 26, then the clips 34a and 34b may prevent proper skin and hair contact with the cutting edges 22 and 24. Furthermore, the position of the bridge member 26 would be limited by a bottom surface 35a and 35b of the clips 34a and 34b. In certain embodiments, it may be advantageous for the primary cap surface 28 and the secondary guard 38 of the bridge member 26 to be positioned on a plane above the cutting edges 22 and 24. The cutting edges 22 and 24 may be preloaded against the bottom surface 35a and 35b of the clips 34a and 34b. The positioning of the bridge member 26 above the cutting edges 22 and 24 may allow for a more comfortable shave.

The bridge member 26 may include a primary cap 36 nearest the first blade 18 and a secondary guard 38 nearest the second blade 20. Accordingly, the primary guard 18 and the primary cap 36 may establish a shaving plane for the first cutting edge 22. Similarly, the secondary guard 38 and the secondary cap 16 may establish the shaving plane for the second cutting edge 24. The primary cap 36 and the secondary guard 38 may be a unitary member that is molded integrally with the bridge member 26 and the housing 12. The bridge member 26 may have a top surface 40 between the primary cap 36 and the secondary guard 38. In certain embodiments, the top surface 40 of the bridge member 26 may have a glossy surface (e.g., 6000 Grit Diamond Buff to 1200 Grit Diamond Buff) to improve glide during a shaving stroke. The bridge member 26 may be coated (e.g., with poly-para-Xylylene or PTFE) or plated (e.g., chrome plating) to improve lubricity. Alternatively, top surface 40 of the bridge member 26 may have a very rough surface to provide for exfoliation of the skin during a shaving stroke (e.g., 600 grit stone or less).

The bridge member 26 may be insert injection molded or co-injection molded to the housing 12. However, other known assembly methods may also be used such as adhesives, ultrasonic welding, or mechanical fasteners. The bridge member 26 may be molded from a generally rigid material to allow the housing 12 to maintain a consistent geometry during shaving and enhance the ability of the ribs 28 to facilitate lifting and orienting hairs. The spaced apart projections 62 may be of sufficient stiffness such that they generally do not bend or flex under normal shaving conditions, which may adversely influence shave geometry. In certain embodiments, bridge member 26 may be molded from the same material as the housing 12, for example, Noryl™ (a blend of polyphenylene oxide (PPO) and polystyrene developed by General Electric Plastics, now SABIC Innovative Plastics). bridge member 26 may be molded from other semi-rigid polymers e.g., materials having a Shore A hardness of about 50, 60 or 70 to about 90, 110, or 120. For example, high impact polystyrene (HIPS), polypropylene (PP), acrylonitrile butadiene styrene (ABS), polycarbonate (PC), and combinations thereof may also be used.

In certain embodiments, the bridge member 26 may be molded from a softer material (i.e., lower durometer hardness) than the housing 12. For example, the bridge member 26 may have a Shore A hardness of about 20, 30, or 40 to about 50, 60, or 70. The bridge member 26 may be made from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs (e.g., Kraton), polyester TPEs (e.g., Hytrel), polyamide TPEs (Pebax), polyurethane TPEs, polyolefin based TPEs, and blends of any of these TPEs (e.g., polyester/SEBS blend). In certain embodiments, housing 12 may include a softer material, for example, a thermoplastic elastomer, such as, Kraiburg HTC 1028/96, HTC 8802/37, HTC 8802/34, or HTC 8802/11 (KRAIBURG TPE GmbH & Co. KG of Waldkraiburg, Germany). A softer material may enhance skin stretching, as well as provide a more pleasant tactile feel against the skin of the user during shaving. A softer material may also aid in masking the less pleasant feel of the harder material of the housing 12 against the skin of the user during shaving.

It is believed, without being held to theory, that it is possible improve the efficiency of removing longer body hair by optimizing the spacing of the blade member 26 and the cutting edges 22 and 24. Multi-blade shaving razor cartridges take advantage of what is known as the hysteresis effect. Hysteresis is the meta-stable extension of hair that occurs after a hair is cut during shaving. In present day razors, sharp cutting edges of the cartridge engage with individual hairs during a shaving stroke, exerting a force on the hairs and causing them to be lifted out of the follicle as the razor is moved across the surface of the skin. Once the hair has been cut and the force is removed, the hair retracts back into the skin. However, in multi-bladed systems, a trailing blade (i.e., second blade) engages the hair and cuts it before the hair is able to retract back into the skin. This concept of consecutive blades cutting hairs before they have fully retracted into the skin is known as “hysteresis cutting”. If the second and consecutive blades also engage and pull hairs while cutting, it becomes possible to get a significantly closer cut than when using a single blade razor.

In razor cartridges with multiple, closely spaced blades it is possible that a single hair may be subjected to engagement with more than one blade during a single cutting episode, multiplying the stimulation of the nerve and the sensation of discomfort. Less closely spaced blades are less likely to engage the same hair in a single cutting episode and therefore less likely to exaggerate nerve stimulation, and discomfort. It is believed, without being held to theory, that decreasing the likelihood of single hairs engaging with multiple blades during a cutting episode may reduce uncomfortable nerve stimulation. Furthermore, decreasing the likelihood of single hairs engaging with multiple blades during a cutting episode may help prevent the hair from being cut too close or below the skin's surface which may limit growing hair from hair re-entering the epidermis of the skin. In addition, razor cartridges with multiple, closely spaced blades increase clogging caused by cut hairs and shaving debris. As body hair is typically longer than facial hair and the body has a much larger surface area than the face, the problem of clogging is further exacerbated when shaving the body. Consumers also typically take much longer strokes when shaving their body compared to when they are shaving their faces.

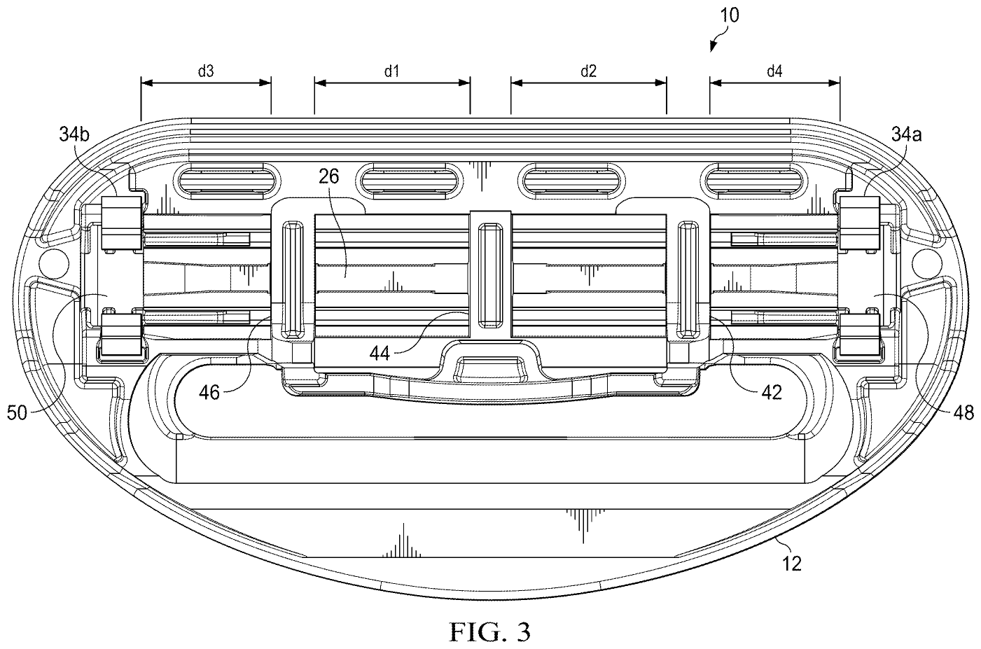

As shown in FIGS. 2 and 3, the housing may have a plurality of beams 42, 44 and 46 that support the bridge member 26. The bridge member 26 may be integrally molded as part of the housing 12 and thus may not have sufficient stiffness as a bridge member that was metal (e.g., steel or aluminum). Accordingly, in certain embodiments, the beams 42, 44 and 46 may be needed to prevent the bridge member 26 from flexing under normal shaving conditions, which may negatively impact shave performance. In certain embodiments, the beams may be spaced apart by a distance d1 and d2 of 5 mm to 10 mm and more preferably 6 mm to 9 mm. The beams 42 and 46 may be spaced apart from a respective side support 48 and 50 of the housing 12 by a distance d3 and d4 of 2 mm to 8 mm and more preferably 5 mm to 7 mm. One or more of the beams 42, 44 and 46 may also include a plurality blade support members 52, 54, 56, 58, 60, 62, 64 and 66. The blade 18 may be mounted between the blade support members 52 and 54 of the beam 42 and the blade support member 56 and 58 of the beam 46. The blade 20 may be mounted between the blade support members 60 and 62 of the beam 42 and the blade support member 64 and 66 of the beam 46.

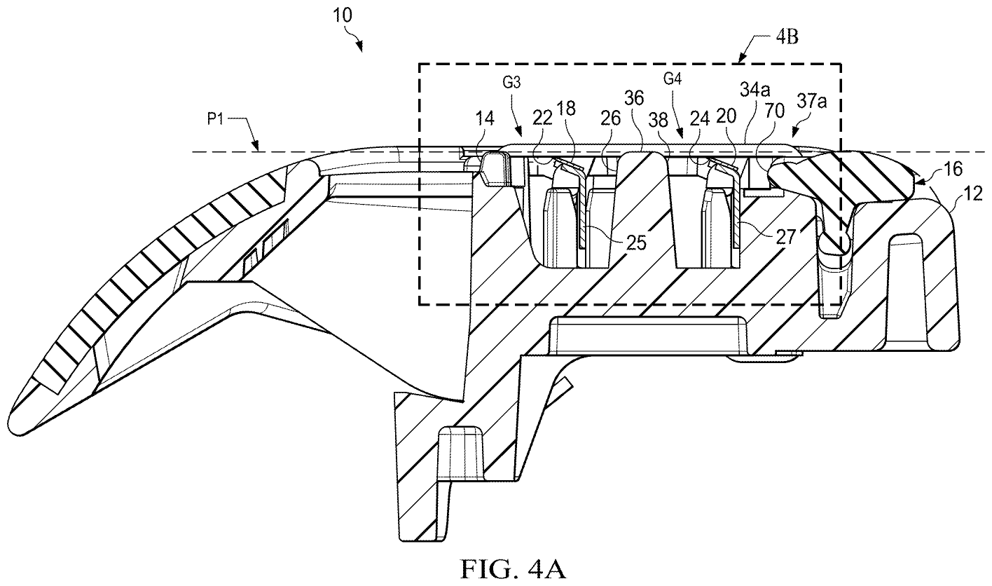

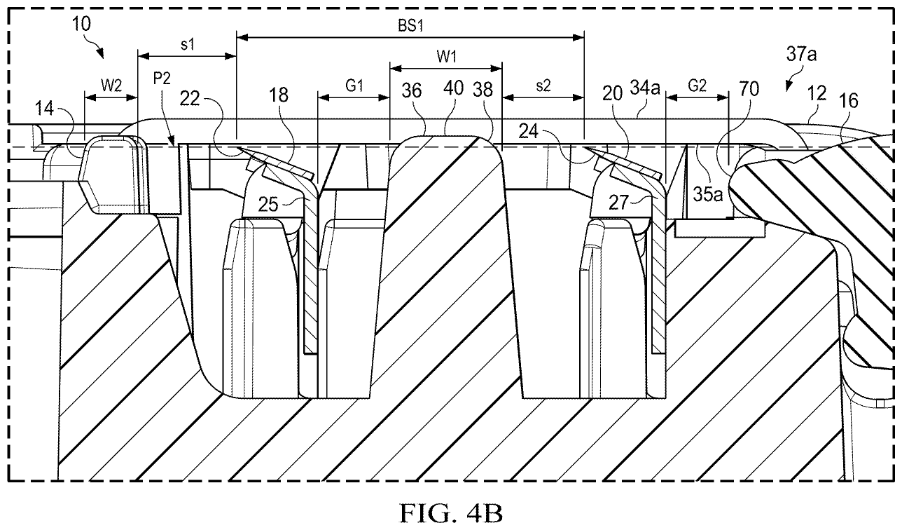

Referring to FIG. 4A a section view of the shaving razor cartridge 10, taken generally along the line 4-4 of FIG. 1 is illustrated. FIG. 4B shows an enlarged section view of the shaving razor cartridge 10 of FIG. 4A. The primary guard 14 may have a width “W2” of 0.35 mm to 0.85 mm. The width W1 of the bridge member 26 may be greater than W2. The width “W1” may be measured as an overall width of the bridge member 26 (in a front to rear direction) measured at a plane P2 tangent to the cutting edges 22 and 24 (e.g., plane P2 may be at bottom surface 35a of the clip 34a). The width of the bridge member 26 may facilitate establishing proper shaving geometry and prevent hair from being cut below the skin surface. For example, the width W1 of the bridge member 26 may facilitate sufficient spacing between the cutting edges 22 and 24 to allow the hairs to retract back into the hair follicle after being cut by the cutting edge 22 of the first blade 18 prior to being engaged by the cutting edge 24 of the second blade 20. Furthermore, the width and spacing of the bridge member 26 may reduce double engagement of hair (e.g., when both cutting edges 22 and 24 engage the same hair at the same time).

In certain embodiments, a first blade span “BS1” between the cutting edge 22 of the first blade 18 and the cutting edge 24 of the second blade 20 may be greater than 3.0 mm. For example, the first blade span “BS1” between the cutting edge 22 of the first blade 18 and the cutting edge 24 of the second blade 20 may be 3 mm to 6 mm. In certain embodiments, the first blade span BS1 may be 3.5 mm to 5.0 mm. The first span BS1 may help minimize double engagement of hair and hysteresis, which may result in discomfort and hairs being cut below the skin surface.

The bridge member 26 may be positioned between the primary guard 14 and the secondary cap 16. A first gap G1 may extend between the first blade 18 and the primary cap 36 of the bridge member 26, as shown in FIG. 4B. It is understood the first gap G1 may extend to the part of the first blade 18 that is closest to the primary cap 36, which in certain cases may be the blade support member 25 of the first blade 18, as shown in FIGS. 4A and 4B. In certain embodiments, the first gap G1 may be 0.60 mm to 1.25 mm and more preferably 0.75 mm to 1.0 mm to provide improved rinsing longer hairs of the housing 12 and minimizing the increased hysteresis which may occur with cutting longer hairs. The first gap G1 may extend completely through the housing 12. Accordingly, less shaving debris may be present when the second blade 20 engages and cuts hair, thus resulting in a more efficient and comfortable shave. A second gap G2 may extend between the second blade 20 and the secondary cap 16 (e.g. a front face 70 of the secondary cap 16). It is understood the second gap G2 may extend to the part of the second blade 20 that is closest to the front face 70 of the secondary cap 16, which in certain cases may be the blade support member 27 of the second blade 20, as shown in FIGS. 4A and 4B. In certain embodiments, the second gap G2 may be 0.60 mm to 1.25 mm and more preferably 0.75 mm to 1.0 mm to provide improved rinsing of the housing 12. The second gap G2 may extend through the housing 12.

A first span s1 that extends from the primary guard 14 to the cutting edge 20 of the first blade 18 may be greater than or equal to 1.05 mm. The first span s1 may allow for improved efficiency in cutting longer hairs, such as when a user is shaving their chest hair. In certain embodiments, the first span s1 may be 1.05 mm to 1.50 mm and more preferably 1.05 mm to 1.15 mm. The sum of the first span s1 and the first gap G1 may provide for more efficient rinsing and cutting of hair. In certain embodiments, the sum of the first span s1 and the first gap G1 may be about 1.75 mm to about 2.50 mm.

A second span s2 may extend between the cutting edge 24 of the second blade 20 and the secondary guard 38 of the bridge member 26. In certain embodiments, the second span s2 between the secondary guard 38 and the cutting edge 22 of the second blade 20 may be less than the first span s1. For example, the second span s2 may be greater than 0.60 mm, but less than 1.25 mm, and more preferably the second span s2 may be 0.80 mm to 1.0 mm. The sum of the second span s2 and the second gap G2 may provide for more efficient rinsing and cutting of hair. In certain embodiments, the sum of the second span s2 and the second gap G2 may be about 1.50 mm to about 2.05 mm. It is believed, without being held to theory that the second span s2 may be less than the first span s1, because the hair is shorter after being cut by the first blade 18. However, the first span s1 may be large enough to allow sufficient rinsing of longer hairs being cut, such as body hair. The first span s1 and the second span s2 may be measure at the second plane P2.

The housing 12 may define a third gap G3 to provide rinse opening below the first span s1 (i.e., between the primary guard 14 to the cutting edge 20 of the first blade 18). The third gap G3 may extend completely through the housing 12. Similarly, the housing 12 may define a fourth gap G4 to provide rinse opening below the second span s2 (i.e., between the secondary guard 38 and the cutting edge 22 of the second blade 20). The fourth gap G4 may extend completely through the housing 12. It is understood the first gap G1, the second gap G2, the third gap G3 and the fourth gap G4 may be interrupted by the beams 42, 44 and 46. However, the size of the first gap G1, the second gap G2, the third gap G3 and the fourth gap G4 may compensate for clogging issues caused by the beams 42, 44 and 46. The third gap G3 may have the same dimensions as the first span s1 and the fourth gap G4 may have the same dimensions as the second span s2.

The primary cap 36 and the secondary guard 38 may be arcuate to provide a comfortable skin support surface. The top surface 40 of the bridge member 26 between the primary cap 36 and the secondary guard 38 may be flat. It is understood that although the bridge member 26 is shown as a flat rectangular shape, numerous other shapes are also possible, such as rounded surfaces or other shapes. The top surface 40 of the bridge member 26 may be positioned on a plane P1 between a top surface 37a and a bottom surface 35a of the clip 34a. Although only one clip 34a is shown in FIGS. 4A and 4B, it is understood clip 34b (not shown) may also have a corresponding top surface and bottom surface. As will be explained in greater detail below, the bridge member 26 (e.g., top surface 40 of the bridge member 26) may be spaced apart (i.e., not contacting) the clips 34a and 34b to facilitate proper shaving geometry and minimize the obstruction of the clips 34a and 34b on a shaving stroke. Accordingly, the position of the bridge member 26 (e.g., height of the bridge member 26 relative to the cutting edges 22 and 24 of the blades 18 and 20) may be independent of the clips 34a and 34b. For example, the top surface 40 of the bridge member 26 may be positioned above the top surface 37a of the clip 34a and the cutting edges 22 and 24. It is understood, the top surface 40 of the bridge member 26 may also be positioned above the top surface 37b of clip 34b in a similar manner.

The position of the bridge member 26 may be fixed relative to the primary guard 14. For example, the bridge member 26 and the primary guard 14 may be integrally formed as part of the housing 12. However, the cutting edges 22 and 24 may be preloaded against the bottom surface 35a of the clip 34a (and clip 34b, not shown). Accordingly, the cutting edges 22 and 24 may float (i.e., move in an up and down direction toward and away from the clips 34a and 34b) during a shaving stroke while the position of the bridge member 26 remains fixed. It is believed, while not being held to theory, the combination of floating blades with fixed surfaces that establish the shaving plane (e.g., the primary guard 14, the primary cap 36, the secondary guard 38 and the secondary cap 16) may provide a more consistent and comfortable shave.

As the first blade span BS1 increases (see FIG. 2), skin bulge between the cuttings edges 22 and 24 may also increase, which may result in increased nicks and cuts. The width W1 of the bridge member 26 may provide sufficient skin support to minimize skin bulge without buckling under normal shaving conditions, which can result in nicks, cuts and discomfort, especially as the first blade span BS1 increases. The width W1 of the bridge member 26 may also be small enough so it does not cause clogging or hamper rinsing. In certain embodiments, the width “W1” of the bridge member 26 may be less than 40% of the first blade span BS1. For example, the width “W1” of the bridge member 26 may be 20% to 40% of the first blade span BS1. Accordingly, if the first blade span BS1 is 5.0 mm, then the bridge member may be 1.0 mm to 1.5 mm. It is understood that the first blade span BS1 may be larger or smaller than 5.0 mm. The bridge member 26 with an increased width may provide increased skin support that results in a more comfortable shave by reducing skin bulge while also minimizing double engagement of hairs and hysteresis.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Furthermore, dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor cartridge comprising:
a housing having a primary guard at a front of the housing, a secondary cap at a rear of the housing;
a bridge member positioned between the primary guard and the secondary cap, the bridge member having a primary cap and a secondary guard;
a first blade mounted to the housing between the primary guard and the primary cap, the first blade member having a first cutting edge closest to the primary guard;
a first gap extending from the first blade to the bridge member of 0.70 mm to 1.25 mm;
a second blade mounted to the housing between the secondary guard and the secondary cap, the second blade member having a second cutting edge closest to the secondary cap,
a second gap extending from the second blade to a front face of the secondary cap a distance of 0.70 mm to 1.25 mm, wherein a first span from the cutting edge of the first blade to the primary guard is greater than or equal to 1.05 mm and a second span from the cutting edge of the second blade to the secondary guard is greater than 0.60 mm.

2. The shaving razor cartridge of claim 1 wherein a width of the bridge member is greater than the first span.

3. The shaving razor cartridge of claim 1 wherein a width of the bridge member is greater than the second span.

4. The shaving razor cartridge of claim 1 wherein a width of the bridge member 1.0 mm to 2.25 mm.

5. The shaving razor cartridge of claim 1 wherein a width of the bridge member 1.0 mm to 1.25 mm.

6. The shaving razor cartridge of claim 1 wherein a sum of a width of the first blade member, a width of the second blade member and a width of the bridge member is less than a sum of the first gap, the second gap, the first span and the second span.

7. The shaving razor cartridge of claim 1 wherein the second span is 0.80 to 1.0 mm.

8. The shaving razor cartridge of claim 1 wherein the first gap is 0.60 mm to 1.25 and the second gap is 0.60 mm to 1.25 mm.

9. The shaving razor cartridge of claim 1 wherein a span from the cutting edge of the first blade member to the cutting edge of the second blade member is 3 mm to 6 mm.

10. The shaving razor cartridge of claim 1 wherein a position of the bridge member is fixed relative to the housing and the first and second blades members are mounted on a pair of respective spring members within the housing.

11. The shaving razor cartridge of claim 1 wherein a top surface of the bridge member is positioned above a plane tangent to the cutting edge of the first blade member and the cutting edge of the second blade member.

12. The shaving razor cartridge of claim 1 wherein a top surface of the primary guard is positioned above a plane tangent to the cutting edge of the first blade member and the cutting edge of the second blade member.

13. A shaving razor cartridge comprising:
a housing having a primary guard at a front of the housing, a secondary cap at a rear of the housing;
a bridge member positioned between the primary guard and the secondary cap, the bridge member having a primary cap and a secondary guard;
a first blade member having a first cutting edge closest to the primary guard, the first blade mounted to the housing between the primary guard and the primary cap;
a first gap extending from the first blade to the bridge member 0.70 mm to 1.25 mm;
a second blade member having a second cutting edge closest to the secondary cap, the second blade mounted to the housing between the secondary guard and the secondary cap,
a second gap extending from the second blade to a front face of the secondary cap 0.70 mm to 1.25 mm.

14. The shaving razor cartridge of claim 13 wherein the first gap is less than a first span extending from primary guard to the first cutting edge.

15. The shaving razor cartridge of claim 13 wherein the second gap is less than a second span extending from secondary guard to the second cutting edge.

16. The shaving razor cartridge of claim 13 wherein the housing comprises a pair of side supports and a plurality of spaced apart beams positioned between the pair of side supports that support the bridge member.

17. The shaving razor cartridge of claim 13 wherein at least two of the beams are spaced apart by 5 mm to 10 mm.

18. The shaving razor cartridge of claim 16 wherein the bridge member has a width of 1.0 mm to 2.25 mm.

19. The shaving razor cartridge of claim 13 wherein a first span from the cutting edge of the first blade to the primary guard is greater than a second span from the cutting edge of the second blade to the secondary guard.

20. The shaving razor cartridge of claim 13 wherein the first span is greater than or equal to 1.05 mm.
